(19) United States
(12) Patent Application Publication
(10) Pub. No.: US 2006/0167585 A1
(43) Pub. Date: Jul. 27, 2006

(54) Personalized book kit, methods of making a personalized book, and a personalized book produced thereby

(76) Inventor: Stanley A. Lebovic, Baltimore, MD (US)

Correspondence Address: J. Bruce Hoofnagle, P.O. Box 370, Lisbon, MD, 21765-0370, US

(21) Appl. No.: 11/324,956

(22) Filed: Jan. 3, 2006

Related U.S. Application Data
(60) Provisional application No. 60/640,233, filed on Jan. 3, 2005.

(51) Int. Cl. G06F 17/00

(52) U.S. Cl. 700/233

(57) ABSTRACT

A personalized book 40 is to be made with the participation of an individual, who is the subject of a personalized story in the book. The individual is supplied with a book cover 42, sheets 58a through 58f, facilities for securing the sheets within the book cover, instructions for making the personalized book 40 through an interactive interface with a facility at an Internet website location, a website address, and a unique access code 144. Through use of a computer at a remote location geographically spaced from the website location, the individual accesses the website facility, and provides personal data in response to a questionnaire. The personal data is merged, at the website location, with impersonal data previously stored at the website facility to complete the story. The merged data is displayed at the remote location, and can be printed on the sheets 58a through 58f.

This application claims the benefit of U.S. Provisional Application No. 60/640,233, filed Jan. 3, 2005, which is incorporated herein by reference thereto.

### BACKGROUND OF THE INVENTION

This invention relates to a personalized book kit, methods of making the personalized book, and the personalized book produced thereby. More particularly, this invention relates to a kit containing component parts of an incomplete story book, methods of completing the story book in a personalized manner, and the personalized book produced by such methods.

Personalized books relate a personalized story, typically about certain activities of an individual, who assisted, in some way, in preparing the story. Such personalized books have been available for many years.

Basically, an impersonalized story is prepared, and requires the inclusion, in the story, of selected data about the individual, in order to personalize the story. This leads to the eventual formation of the personalized book. The impersonalized story may be provided to the individual as a component of a commercially available personalized book kit, with instructions regarding the manner of inserting the individual's personal data into the impersonalized story. Personal involvement, by the individual, in the preparation of the personalized book, provides a measure of satisfaction and ownership in the book, on the part of the contributing individual.

The basic premise of preparing the personalized story and book, as noted above, facilitates personal involvement in such preparation by the individual. However, the techniques employed in the past have limited such personal involvement to the extent that individual satisfaction is limited, and may even be nonexistent.

For example, as described in U.S. Pat. No. 5,397,156, which issued on Mar. 14, 1995, a kit is provided to a purchaser and includes an order form to be completed and mailed, or a telephone number, either of which facilitates the supply of personalized data through the mail, or by voice over the telephone, to someone who is unseen, and unknown, to the purchaser. The personalized story and the book is then prepared without contact with the purchaser, and the end product is sent and delivered to the purchaser. Usually, a considerable period of time transpires between the input of personal data by the purchaser, and the receipt of the completed book through the mail.

As a result of the impersonal contact between the purchaser and the person preparing the finalized story and book, and because of the considerable time required for completion and delivery of the book, the purchaser has essentially lost any semblance of personalized contribution to the finalized story and book.

In an another example, as disclosed in U.S. Pat. No. 5,213,461, which issued on May 25, 1993, a computer operator is situated at a computer at a retail site. A purchaser, at the retail site, conveys directly to the computer operator, at the retail site, the purchaser's selection of a predetermined story, and further conveys personalized information directly to the computer operator. The computer operator accesses a control program, stored in the computer at the retail site, which contains the selected story, and enters, through the computer, the personalized data into the predetermined story program.

The computer operator transfers a full text version of the predetermined story and the incorporated personalized information from the computer to a printer at the retail site, adjacent the computer, where a personalized story is then printed on sheets of paper. Each sheet of the paper forms two pages of a book which will contain the personalized story. After the printing operation, the computer operator separates the sheets transversely into pages, assembles the pages in a predetermined order and then into a jacket of the book, and presents the completed book, with the personalized story, to the purchaser.

The technique described in U.S. Pat. No. 5,213,461 does not allow the purchaser to personally participate in the preparation of the book, other than orally conveying, to the computer operator, the selection of the story, and the personal information. The purchaser then stands idly by, at the retail site, while the computer operator, also at the retail site, proceeds through various physical acts leading to the creation and printing of the personalized story, and the assembly of the printed pages into the book jacket.

Thus, the purchaser never handles any of the physical elements of the book during preparation thereof, and is never involved with the actions associated with operation of the computer during preparation of the book. The purchaser touches and handles the finalized book only after the book has been completed. With this technique, the purchaser is deprived of any personal satisfaction resulting from performing the physical actions leading to the preparation and completion of the purchaser's personalized story and book.

In U.S. Pat. No. 6,012,890, which issued on Jan. 1, 2000, a system and a method for providing books on demand is described, wherein a user can browse through an electronic catalog, for example over the Internet, and place an order for an existing complete book. The book can then be printed and bound at an electronic bookstore, and later picked up at the electronic bookstore by the user. While the process disclosed in this patent utilizes the Internet to place an order for an existing book, there are no provisions, disclosed in this patent, for making a personalized book, or participating in the development of a personalized story, by the subject of the story.

In U.S. Pat. No. 6,088,710, which issued on Jul. 11, 2000, a method of assembling fulfillment pieces with custom documents is described. An original database, containing document recipient information, is manipulated by adding rows or columns to the original database to represent the custom document and the fulfillment pieces. The modified databases are used to create press commands, to produce ordered output from a press, or a demand printer.

Alternatively, as described in U.S. Pat. No. 6,088,710, master and variable page files may be premerged to create a plurality of combined files, which can be converted to a PDF format and transmitted to networked or linked computers, using a facsimile machine, e-mail, the Internet/World Wide Web, a company intranet or other transmission medium. A customized Internet page could be sent with links to other web pages of interest to a user, or a customized page may be sent in response to a user search for information on a particular subject.

While the process disclosed in U.S. Pat. No. 6,088,710 utilizes the Internet to transmit data, there are no provisions, disclosed in this patent, for making a personalized book, or allowing participation in the development of a personalized story, by the subject of the story.

### SUMMARY OF THE INVENTION

An object of the preferred embodiment of this invention is to provide a method of making a personalized book containing a personalized story, wherein the individual or subject of the story actively participates in the preparation of the personalized story and in the assembly of elements of the book, which contains the story.

Another object of the preferred embodiment of this invention is to provide a method of making a personalized book containing a personalized story, wherein an individual or subject of the story actively participates, through an interactive interface, in preparation of the personalized story, by computer use at a first location, and through the Internet to an Internet website facility at a second location, geographically spaced from the first location.

A further object of the preferred embodiment of this invention is to provide a method of distributing a plurality of personalized-book kits through a retail outlet, wherein each purchaser of a respective one of the plurality of kits receives a unique access code. The unique assess code provides personal and unique access, by the purchaser, to a specific Internet website facility, which allows the purchaser to actively participate in the preparation of the personalized story.

With these objects in mind, the preferred embodiment of this invention contemplates a method of making a personalized book containing a personalized story, through participation by an individual, who is the subject of the personalized story, or by a person acting for the individual. Under this method, a fixed data file for storing fixed data therein, and a variable data file for storing variable data therein, are located at a common site. Fixed data, representative of nonvariable data associated with the story, is stored in the fixed data file at the common location.

The individual, who is at a remote site geographically spaced from the common site, selects variable data in the form of a word or phrase designating the individual to be referenced in the story, with the variable data then being transmitted from the remote site to the common site. The transmitted variable data is then stored in the variable data file at the common site.

The stored fixed data and the stored variable data are then merged at the common site into a format of merged data, which is transmitted from the common site to the remote site, where the merged data is displayed in a human-readable format at the remote site.

The preferred embodiment of this invention further contemplates a method of making a personalized book, where the displayed merged data can be printed on at least one sheet of paper, at the remote site.

Additionally, the preferred embodiment of this invention contemplates a method of making a personalized book containing a personalized story, wherein a fixed data file, for storing fixed data therein, and a variable data file, for storing variable data therein, are established in a server located at a physical location of an Internet website facility. Fixed data, relating in an impersonalized manner to the story, without reference to any individual, is prepared and stored in the fixed data file.

A questionnaire, requiring personalized responses from an individual who is to be the subject of the story, or a person acting for the individual, is prepared and stored in a recallable data repository located in the server at the Internet website facility. The individual is provided with (1) the Internet address of the website, and (2) an access code unique to the individual at the remote site, which facilitates access, through the website facilities, to the questionnaire and to the variable data file.

By using a computer, the website address, and the unique access code, the individual, who is now located at a remote site geographically spaced from the physical facility of the Internet website, accesses the server at the Internet website facility. The variable data, generated by the individual in response to the questionnaire, is transmitted from the remote site to the variable data file at the Internet website facility. The transmitted variable data is stored in the variable data file, and the fixed data and the variable data, in the server at the Internet website facility, are merged into a format of merged data representative of the complete personalized story. The merged data is transmitted from the server at the Internet website facility to the remote site, and is displayed, at the remote site, in a human-readable format.

Further, the preferred embodiment of this invention contemplates a web-based method of making a plurality of personalized books for a plurality of individuals, wherein each individual will receive a kit containing instructions which guide the individual in making the individual's personal book. Initially, the services of an Internet website operator are engaged, wherein the operator has an Internet website facility and a server at a website location, and an Internet website address. A fixed data file, for storing fixed data therein, and a variable data file, for storing variable data therein, is established in the server. Fixed data, relating to impersonalized aspects of the story, without inclusion of, or reference to, any individual or characteristics associated with an individual, is prepared and stored in the fixed data file.

A questionnaire is prepared, requiring responses which reference, by one or more words or phrases, the individual, and one or more characteristics thereof, to be included in the individual's personalized story, and is stored in a recallable data repository located in the server. An access code is prepared, which will allow the individual to access the server, including access to the questionnaire stored in the recallable data repository, and the variable data file.

The kit, which includes (1) the Internet address of the website, and (2) the access code, is distributed to the individual. The individual, from a remote site which is geographically spaced from the Internet website facilities, logs on to the website, through the use of (1) a computer located at the remote site, (2) the Internet address, and (3) the access code, to establish an interactive interface between the individual and the Internet website facilities at the website location.

The questionnaire is transmitted from the website location to the remote site for display on a monitor at the remote site. The individual at the remote site, submits responses to questions on the monitor-displayed questionnaire, which generates variable data representing personalized information regarding the individual. The variable data, generated by the individual in response to the questionnaire, is transmitted to, and stored in, the variable data file at the website location. The fixed data and the variable data, stored in the server at the website location, are merged into a format of merged data representative of a complete personalized story unique to the individual. The merged data from the server at the website location is transmitted to the remote site, and is displayed on the monitor at the remote site in a human-readable format.

The preferred embodiment of this invention further contemplates a web-based method of making a plurality of personalized books for a plurality of individuals. After preparing the personalized access code for each of the individuals, a plurality of kits, with each kit including (1) the Internet address of the website, and the (2) the access code, are distributed to retailers for display and sale thereof. Each individual, who purchases one of the plurality of kits, is provided with the instructions therein to facilitate completion of the individual's personalized book.

The preferred embodiment of this invention also contemplates a book, having a book cover formed by a plurality of independent slats extending from a top edge of the book cover to a bottom edge of the book cover. The plurality of independent slats are arranged in a side-by-side separated relation, and are located in a common plane when the book cover is in a flat plane. Means are provided for retaining the plurality of independent slats of the book cover in their side-by-side separated relation.

Further, the preferred embodiment of this invention also contemplates a book, which includes means for allowing the book cover to be rolled to form a rolled book.

Additionally, the preferred embodiment of this invention contemplates a book, having a book cover which is formed with a spine, located intermediate a first side edge of the book cover and a second side edge of the book cover. The book cover is foldable along the spine thereof. A front cover of the book is formed by a first portion of the book cover, which extends laterally from the spine to the first side edge of the book cover. A back cover of the book is formed by a second portion of the book cover, which extends laterally from the spine to the second side edge of the book cover. Means are provided for allowing the front cover and the back cover to be rolled to form a rolled book.

Further, the preferred embodiment of this invention contemplates a book with a cover having an opening formed in a portion thereof. A first portion of the edge of the opening has an appearance of the cover having been randomly torn from the remaining adjacent sections of the cover, and a second portion of the edge of the opening formed with spaced notches. A sheet is placed within the cover, and a graphic illustration of a paw and claws of an animal appear on the sheet, which is visible through the opening in the cover, with the graphic illustration of the claws being visible through the notches to represent that the opening in the cover has been formed by the claws of the animal from within the cover.

Also, the preferred embodiment of this invention contemplates a book kit, which includes a container formed with a closed base, and an open top spaced from the closed base, with an axis extending between the base and the open top of the container. The container is formed with a well having a closed side wall which extends along the axis of the container from the base of the container toward the open top of the container. The well of the container is formed with a prescribed transaxial dimension.

The book kit includes a book cover, which has a prescribed width dimension extending between a first side edge of the cover and a spaced second side edge of the cover when the cover is in a flat plane. The prescribed width dimension of the book cover is greater than the prescribed transaxial dimension of the well of the container. The cover of the book is structured to allow rolling of the book about an axis to thereby form a rolled book, with the rolled book having a transaxial dimension which is less than the prescribed transaxial dimension of the well of the container. The rolled book is locatable within the well of the container.

In addition, the preferred embodiment of this invention contemplates a book stand for supporting a book having a front cover and a back cover. The book stand includes a support mount shaped in a configuration of a bottle having an axis extending from a closed base of the support mount to a top of the support mount, and is formed with a side wall. The support mount is formed with a support-mount well extending from the base toward the top of the support mount and is surrounded, at least partially, by the side wall. A side opening is formed in an intermediate section of the support mount, with the side opening being in communication with the well of the support-mount. The side opening has a lower edge adjacent the base and an upper edge closer to the top of support mount than the lower edge. A ledge is formed at the lower edge of the side opening on a first side of the support mount for engaging an edge of, and supporting, the book. Spaced supports are formed in the support mount and extend from the ledge toward the upper edge of the side opening of the support mount. The spaced supports also extend angularly away from the ledge toward a second side of the support mount, opposite the first side thereof, for engaging the back cover of, and supporting, the book.

Other objects, features and advantages of the preferred embodiment of the invention will become more fully apparent from the following detailed description of the preferred embodiment, the appended claims and the accompanying drawings.

### BRIEF DESCRIPTION OF THE DRAWINGS

In the accompanying drawings:

FIG. 1 is a perspective view showing a personalized book in accordance with certain principles of the invention;

FIG. 2 is a collection view showing a kit containing various elements used for making the personalized book of FIG. 1 in accordance with certain principles of the invention;

FIG. 3 is an front view showing the outside of a cover for the personalized book of FIG. 1 in accordance with certain principles of the invention;

FIG. 4 is a rear view showing the inside of the cover of FIG. 3 in accordance with certain principles of the invention;

FIG. 5 is an exploded perspective view showing the cover of FIG. 3, pages of the personalized book of FIG. 1, and book-securance elements in accordance with certain principles of the invention;

FIG. 6 is a front view showing a plurality of slats, which form the cover of FIG. 3, and the manner of assembly of the plurality of slats in accordance with certain principles of the invention;

FIG. 7 is a perspective view showing the cover of FIG. 3 in a rolled configuration for insertion into a first embodiment of a container in accordance with certain principles of the invention;

FIG. 8 is a perspective view showing a second embodiment of a container in accordance with certain principles of the invention;

FIG. 9 is a perspective view showing the personalized book of FIG. 1 as a rolled book positioned for insertion in the second embodiment of the container of FIG. 8, which is mountable on a support surface in accordance with certain principles of the invention;

FIG. 10 is a front view showing a third embodiment of a container for containing the rolled book of FIG. 9, with a removable side panel, in accordance with certain principles of the invention;

FIG. 11 is a left side view showing the third embodiment of the container of FIG. 10 in accordance with certain principles of the invention;

FIG. 12 is a left side view showing the third embodiment of the container of FIG. 10, with the side panel removed, in accordance with certain principles of the invention;

FIG. 13 is a left side view showing a left side view of a book stand in accordance with certain principles of the invention;

FIG. 14 is a front view showing the book stand of FIG. 13, with the personalized book of FIG. 1 mounted on the stand in accordance with certain principles of the invention;

FIG. 15 is a front view showing the front of the cover of FIG. 3 having an opening therein, which represents the opening being formed by an animal claw from within the book, in accordance with certain principles of the invention;

FIG. 16 is a flow diagram showing one version of the steps leading to the making of the personalized book of FIG. 1 in accordance with certain principles of the invention;

FIG. 17 is a graphic view of a first display on a computer monitor providing an opportunity for an individual, who may be the subject of the personalized story, to select whether the individual wants subsequent displays, and the personalized story, to be printed in the English language or the Spanish language;

FIG. 18 is a graphic view of a second display on the computer monitor requesting whether the individual already has, or doesn't have, the book kit of FIG. 2 in accordance with certain principles of the invention;

FIG. 19 is a graphic view of a third display on the computer monitor requesting that personal information related to the individual be supplied in accordance with certain principles of the inventions;

FIG. 20 is a graphic view of a fourth display on the computer monitor requesting that additional personal information be supplied in accordance with certain principles of the invention; and

FIG. 21 is a graphic view of a fifth display on the computer monitor requesting information regarding the individual's favorite pet in accordance with certain principles of the invention.

### DETAILED DESCRIPTION OF THE PREFERRED EMBODIMENTS OF THE INVENTION

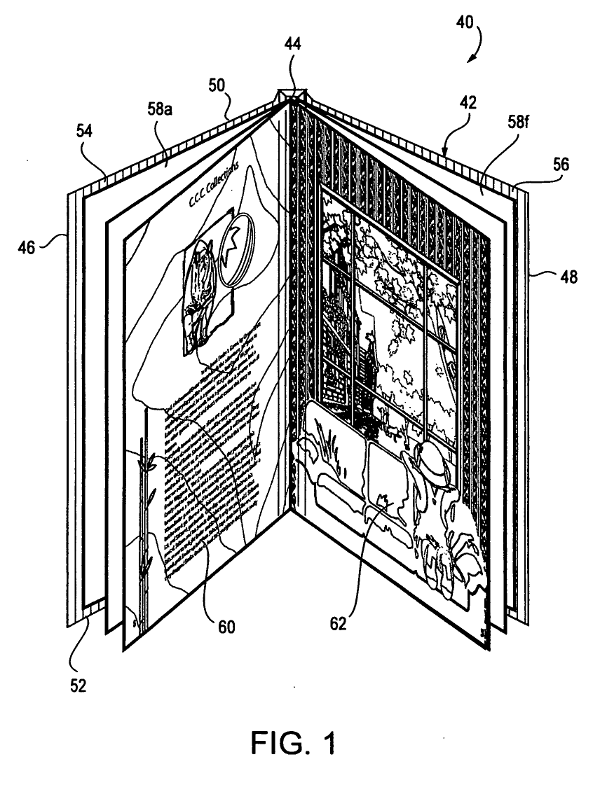

Referring to FIG. 1, a personalized book 40 includes a book cover 42, having a spine 44 (FIGS. 1 and 4) located intermediate a first side edge 46 of the book cover and a second side edge 48 of the book cover. The book cover 42 extends from a top edge 50 thereof to a bottom edge 52 thereof, and is foldable along the spine 44, with a front cover 54 of the book 40 formed by a first portion of the book cover, which extends laterally from the spine to the first side edge 46 of the book cover. A back cover 56 of the book 40 is formed by a second portion of the book cover 42, which extends laterally from the spine 44 to the second edge 48 of the book cover. The book 40, and the book cover 42, are formed with a prescribed width dimension, which extends laterally across the front cover 54, between the spine 44 and the first side edge 46 of the book cover, when the front cover is in a flat plane, as illustrated in FIG. 1.

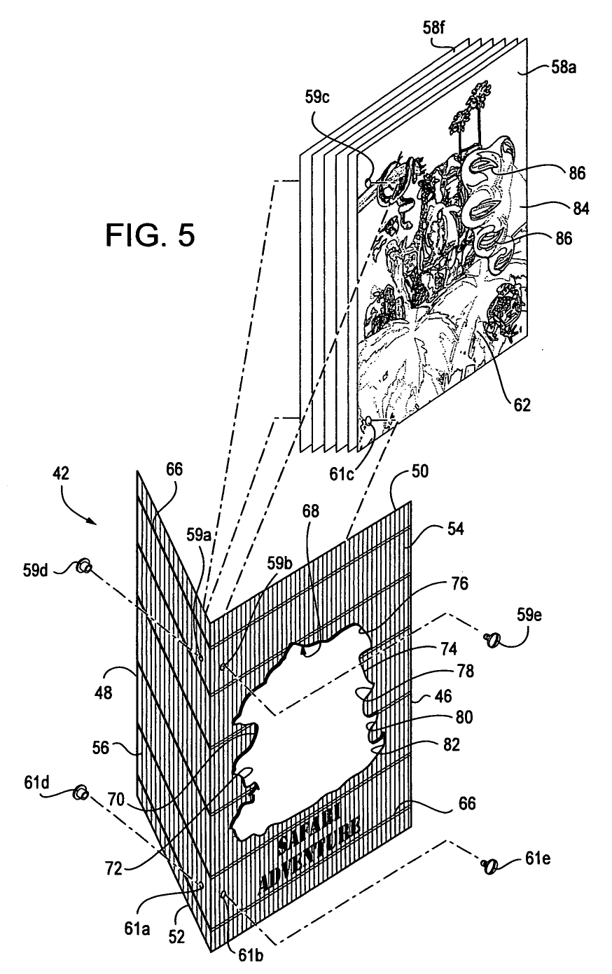

A plurality of individual sheets 58a through 58f as illustrated in FIGS. 1, 2 and 5, are secured, or bound, within the book 40, between the front cover 54 and the back cover 56. As shown in FIG. 5, in order to effect the securance or binding of the sheets 58a through 58f within the book 40, the front cover 54 is formed with a pair of spaced holes 59b and 61b, adjacent the spine 44, and the back cover 56 is formed with a pair of spaced holes 59a and 61a, also adjacent the spine. Each sheet 58a through 58f are formed with a pair of spaced holes 59c and 61c. When the sheets 58a through 58n are assembled with the book cover 42, the holes 59a, 59b, and 59c are aligned, and the holes 61a, 61b, and 61c are aligned. Thereafter, a screw receptor 59d is inserted, from the back cover 56, through the aligned holes 59a, 59b, and 59c, and a screw 59e is inserted, from the front cover 54, into threaded engagement with the threaded receptor. In similar fashion, a screw receptor 61d is inserted, from the back cover 56, through the aligned holes 61a, 61b, and 61c, and a screw 61e is inserted, from the front cover 54, into threaded engagement with the threaded receptor to complete the securance operation.

Each of the sheets 58a through 58f are formed with a front side and a back side. The front side of each sheet 58a through 58f forms odd numbered pages within the book 40, and the back side of each sheet forms even numbered pages. The even numbered pages contain text 60, which relate a personalized story about an individual. Each of the odd numbered pages contain graphic illustrations 62 which blend with, and relate to, the portion of the story appearing in the text 60 on the even numbered page which interfaces with the respective odd numbered page.

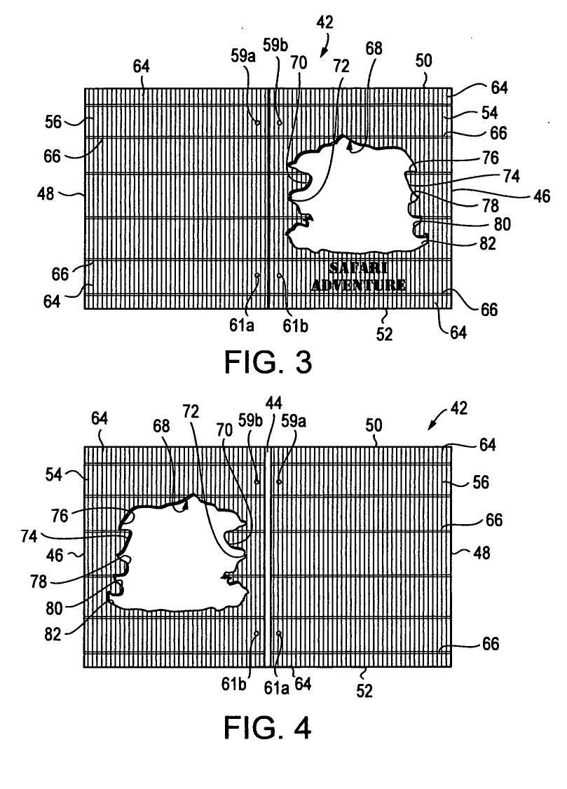

As illustrated in FIGS. 3, 4 and 6, the book cover 42 is formed by a plurality of longitudinal independent slats 64, which extend from the top edge 50 of the book cover to the bottom edge 52 thereof. Each of the plurality of slats 64 is independent from the slats immediately adjacent thereto, and are, therefore, not integrally joined in any manner to the immediately adjacent slats. The plurality of slats 64 are arranged in a side-by-side, but separated, relation, and are located in a common plane when the book cover 42 is in a flat plane, as illustrated in FIGS. 3 and 4.

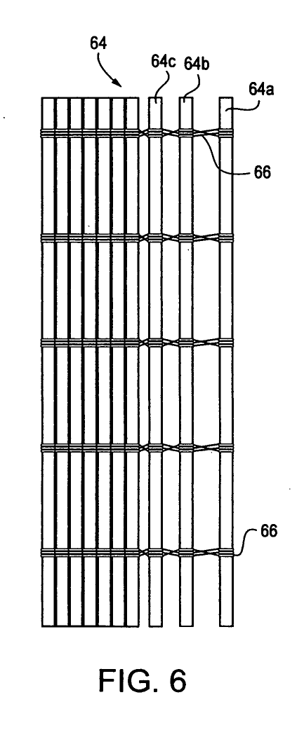

The plurality of slats 64 are retained in the side-by-side separated relation by a plurality of spaced rows of threads 66, which extend between the first edge 46 and the second edge 48 of the book cover 42. As particularly shown in FIG. 6, slats 64a, 64b, and 64c have been moved away from the remaining slats 64, for illustration purposes only, to show the manner in which the threads 66 are interlaced to retain the slats in the side-by-side relation, but allow each of the slats to be separated from, and independent of, the remaining slats. Thus, the interlaced plurality of threads 66 are means for retaining the plurality of independent slats 64 of the book cover 42 in their side-by-side separated relation.

Other techniques could be used to retain the plurality of slats 64 in the above-described relation without departing from the spirit and scope of the invention.

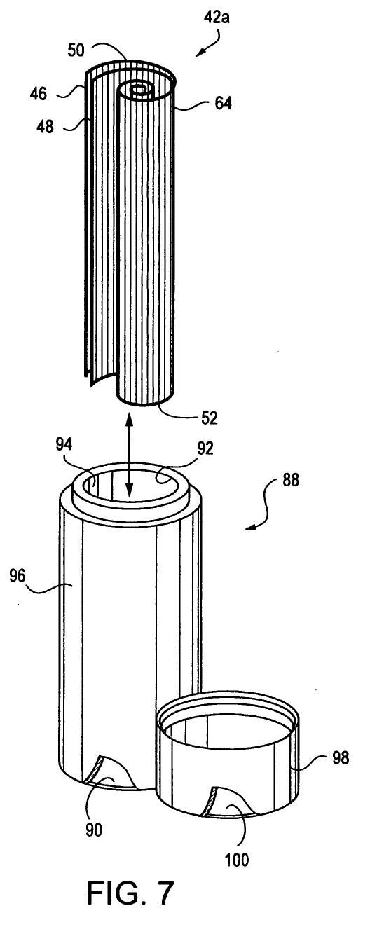

Each of the plurality of slats 64 is vertically inflexible. When the plurality of slats 64 are assembled, and retained by the threads 66, collectively the slats provide vertical inflexibility for the book cover 42, that is, from the top edge 50 to the bottom edge 52 of the book cover. Simultaneously, when the plurality of slats 64 are assembled, and linked by the threads 66, to form the book cover 42, the book cover is flexible horizontally, that is, between the first side edge 46 and the second side edge 48 of the book cover, but remains vertically inflexible. Therefore, with each of the plurality of slats 64 being independent of each other, but retained together by the plurality of threads 66, the book cover 42 can be rolled about a longitudinal axis, as illustrated in FIG. 7, to form a rolled book cover 42a.

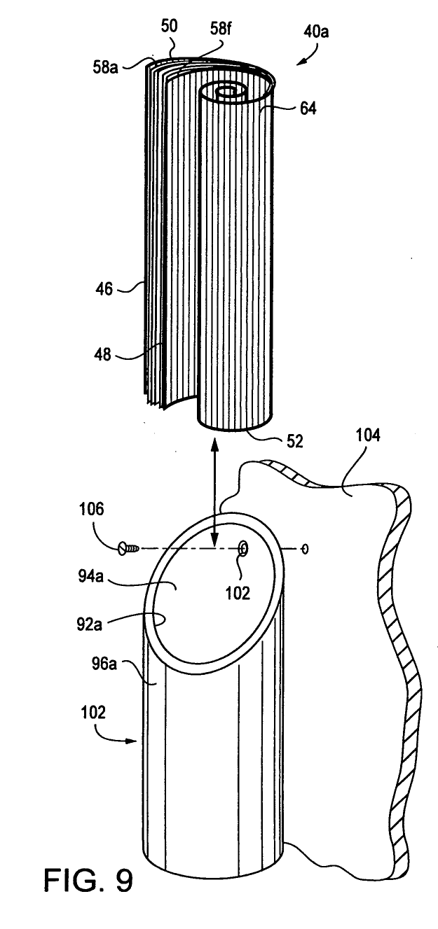

When the personalized book 40 is completed, as illustrated in FIG. 1, the rollability of the book cover 42 allows the personalized book to be rolled into a rolled book 40a, as illustrated in FIG. 9, wherein the rolled book is in a cylindrical-like configuration. Thus, the independent relation between adjacent slats 64 of the plurality of slats, the threaded linking of the slats, and the horizontal flexibility of the book cover 42, forms a means for allowing the book 40 to be rolled to form the rolled book 40a.

Other techniques could be employed to facilitate the rolling of the book cover 42, and the book 40, without departing from the spirit and scope of the invention.

The plurality of independent slats 64 are composed of a material selected from the group of bamboo, wood, plastic, metal, paperboard, and any combination of two or more of bamboo, wood, plastic, metal, and paperboard. Bamboo is the preferred material for the book cover 42.

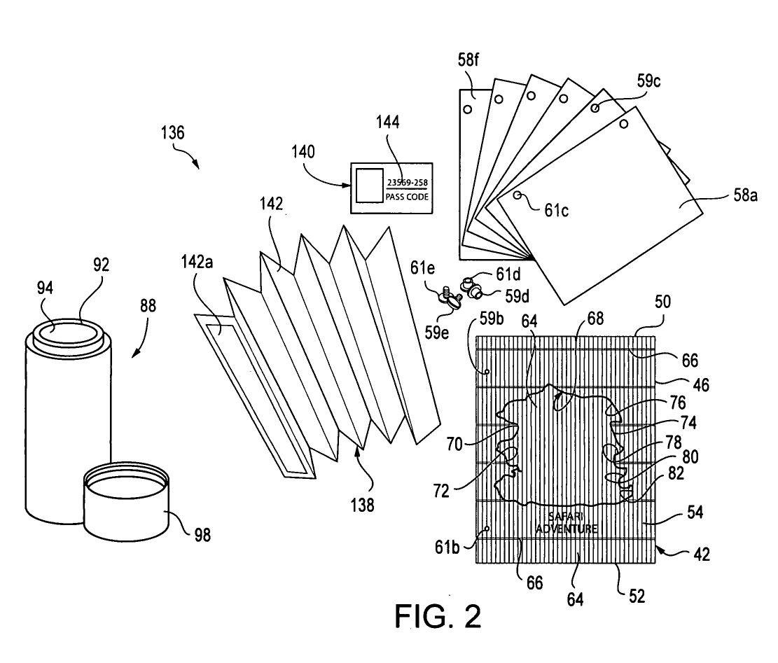

As shown in FIGS. 2, 3, 4, 5, and 15, the front cover 54 is formed with a central opening 68 having an edge 70. A first portion 72 of the edge 70 of the opening 68 has an appearance of the cover 42 having been randomly torn from the remaining adjacent sections of the cover. A second portion 74 of the edge 70 of the opening 68 is formed with spaced notches 76, 78, 80, and 82.

Referring to FIG. 5, the graphic illustration 62 of the front of sheet 58a includes a paw 84 and claws 86 of an animal appearing on the sheet. As shown in FIG. 15, the graphic illustration is visible through the opening 68 of the cover 42, with the graphic illustration of the claws 86 being visible through the notches 76, 78, 80, and 82 to represent that the opening in the cover has been formed by the claws of the animal from within the cover.

Referring to FIG. 15, on the front cover 54 of the personalized book 40, the expression “SAFARI ADVENTURE” has been stenciled into the portions of the plurality of slats 64 just below the opening 68.

As shown in FIGS. 2 and 7, a first embodiment of a container 88, which is the preferred embodiment, is formed with a closed base 90, and an open top 92 spaced from the closed base, with an axis extending between the closed base and the open top. The container 88 is formed with a well 94 having a closed side wall 96, which extends along the axis of the container from the closed base 90 toward the open top 92, of the container. The well 94 is formed with a prescribed transaxial dimension. The container 88 is cylindrical in configuration, and the transaxial dimension of the well is the diameter thereof.

The above-noted prescribed width dimension of the book 40, and the book cover 42, is greater than the prescribed transaxial dimension of the container 88, when the book and the book cover are in a conventional book configuration illustrated in FIG. 1. Therefore, neither the book 40 nor the book cover 42 can be inserted through the open top 92 and into the well 94 of the container 88, when the book and/or the book cover are in the conventional book configuration illustrated in FIG. 1.

As described above, with respect to the plurality of slats 64, the book cover 42 is structured to allow rolling of the book cover about an axis to thereby form the rolled book cover 42a, as shown in FIG. 7, which has a transaxial dimension less than the prescribed transaxial dimension. Therefore, the rolled book cover 42a is locatable within the well 94 of the container 88.

As also described above, when the book 40 is formed, as illustrated in FIG. 1, the book, with the book cover 42, can rolled to thereby form the rolled book 40a, as illustrated in FIG. 9, with the rolled book having a transaxial dimension which is less than the prescribed transaxial dimension of the well 94 of the container 88. Thus, the rolled book 40a is locatable within the well 94 of the container 88.

For storage purposes, the rolled book 40a, and/or the rolled book cover 42a, are inserted through the open top 92, and into the well 94, of the container 88, and a cap 98 is positioned, in a complimentary fashion, over and onto the open top 92 of the container. It is noted that, when the cap 98 is on the open top 92 of the container 88, the axial distance from the closed base 90 of the container to a closed base 100 (FIG. 7) of the cap is greater than the height of the rolled book 40a and/or the rolled book cover 42a.

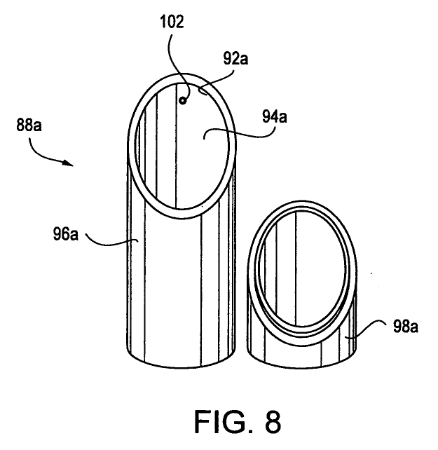

Referring to FIGS. 8 and 9, another embodiment of a container 88a is configured similarly to the configuration of the container 88, except that an open top 92a of the container 88a is beveled in the form of a truncated right circular cylinder. A cap 98a is formed with a shape which is complimentary to an open top 92a of the container 88a, and is positionable over and onto the top of the container. A hole 102 is formed through a side wall 96a of the container 88a to facilitate the selective mounting of the container 88a onto a support wall 104, by use of a screw 106.

The preferred material for the containers 88 and 88a is bamboo. Other materials, such as plastic, glass, metal or paperboard could be used without departing from the spirit and scope of the invention. Also, the containers 88 and 88a are cylindrical. The containers 88 and 88a could be formed in many other configurations without departing from the spirit and scope of the invention.

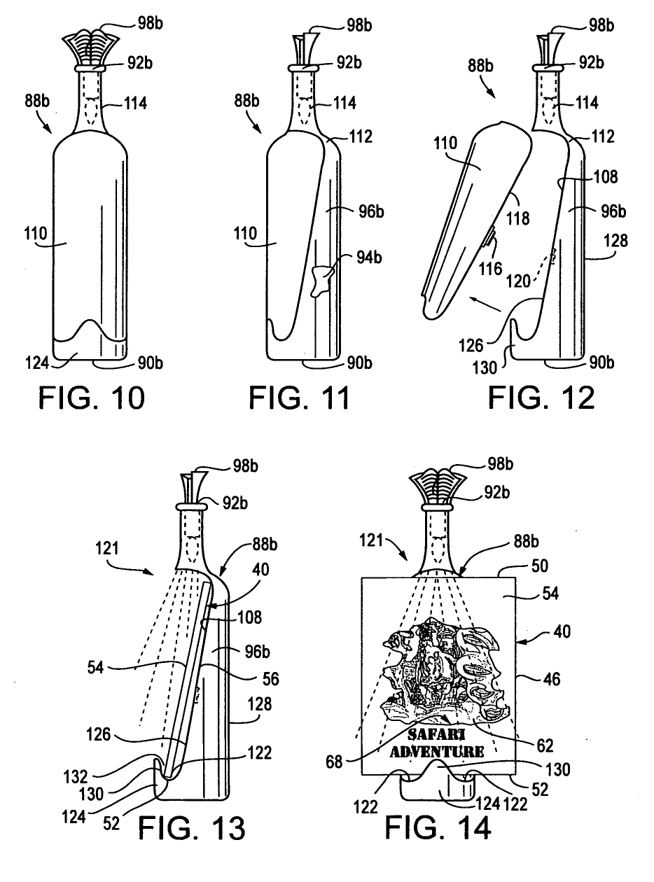

Referring to FIGS. 10, 11 and 12, still another embodiment of a container 88b is formed in the configuration of a bottle, and is formed with a closed base 90b and an open top 92b, with an axis extending therebetween. The container 88b is formed with a well 94b (FIG. 11) having a closed side wall 96b, which extends along the axis of the container from the closed base 90b of the container toward the open top 92b of the container. The well 94b of the container 88b is formed with a prescribed transaxial dimension.

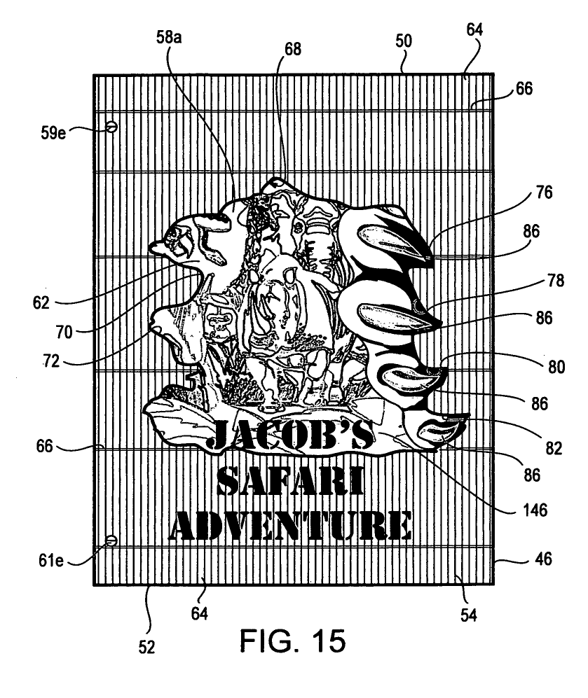

The well 94b of the container 88b is formed with a side wall 96b having a side opening 108 (FIG. 12). A removable side panel 110 is positionable over, and forms a closure for, the side opening 108, to facilitate access to the well 94b within the closed side wall 96b of the container 88b. The well 94b of the container 88b extends axially from the closed base 90b to an intermediate section 112 of the container. The container 88b is also formed with a neck 114, which extends axially from the intermediate section 112 of the container to the open top 92b thereof. The neck 114 of the container 88b is formed with an axial opening extending from the open top 92b toward the closed base 90b of the container, with the axial opening having a transaxial dimension which is less than the prescribed transaxial dimension.

A cap 98b is positionable onto, and covers, the open top 92b of the container 88b. A portion of the cap 98b extends outward from the open top 92b and is formed as a decorative emblem, in the configuration of an open book. A detent 116 is formed on an edge 118 of the side panel 110, and mates with a detent catch 120 to removably retain the side panel with the container 88b.

The prescribed width dimension of the book 40, and the book cover 42, are greater than the prescribed transaxial dimension of the well 94b of the container 88b, as well as the transaxial dimension of the open top 92b. Further, the prescribed width dimension of the book 40, and the book cover 42, are greater than any transaxial dimension of the side opening 108. Therefore, when the book 40, and the book cover 42, are in the conventional book configuration as shown in FIG. 1, the book, and the book cover independent of the book, can not be inserted into the well 94b of the container 88b. In order to insert the book 40, or the book cover 42, into the well 94b of the container 88b, the book, or the book cover, are rolled as described above to the configuration of the rolled book 40a (FIG. 9), or the rolled book cover 42a (FIG. 7). With the side panel 110 removed, the rolled book 40a, or the rolled book cover 42a, can be inserted through the side opening 108 of the container 88b, whereafter the side panel may be placed over the side opening.

The container 88b can be composed of glass or plastic, or any other material suitable for being configured in the shape of a bottle.

As shown in FIGS. 13 and 14, with the side panel 110 of the container 88b removed, the container can be used as a book stand, or support mount, 121. To facilitate such a use, a ledge 122 is formed at a lower edge of the side opening 108 on a first side 124 of the container 88b for engaging the bottom edge 52 of, and supporting, the book 40 in the unrolled configuration. Spaced side edges of the side opening 108 form spaced supports 126 (one shown in FIGS. 12 and 13). The spaced supports 126 extend from the ledge 122 toward the open top 92b of the container 88b, and angularly away from the ledge toward a second side 128 of the container, opposite the first side 124 thereof. With this arrangement, the spaced supports 126 engage the back cover 56 of, and support, the book 40.

The book stand 121 also includes a stop wall 130, which extends from the ledge 122 of the container 88b, and is positioned to engage a portion 132 of the book 40, to prevent the lower edge 52 of the book from moving from the ledge in a direction away from the axis of the container.

The book stand 121 further includes a lamp 134, which is located within the axial opening of the neck 114 of the container 88b, for illuminating the book 40 as supported on the ledge 122 and by the spaced supports 126.

It is noted that the book stand 121 is described above in conjunction with an extended use of the container 88b, following the completion of making the personalized book 40. The book stand 121 could be a separate item, independent of any association with the making and/or selling of a personalized book, and could be marketed as a separate item, that is, as a book stand only.

Referring to FIG. 2, the items which an individual will need to participate in the making of the individual's personalized book 40, can be gathered by a developer of the process of making the book, and placed in the container 88, or any of the other containers 88a and 88b, to form a book kit 136. The book kit 136 includes, as described individually above, the book cover 42 in the configuration of the rolled book cover 42a, the rolled textless pages 58a through 58f, the screw receptors 59d and 61d, and the screws 59e and 61e, an instruction sheet 138, and a pass code card 140, all of which are inserted into the container 88, with the cap 98 thereafter placed on the container. The container 88 and the cap 98 are also items of the book kit 136.

The instruction sheet 138 is folded in an accordion-like fashion, to form a plurality of panels 142. Text-written instructions appear on a panel 142a, and are printed in the English language on one side thereof, and in the Spanish language on the other side thereof. When the instruction sheet 138 is spread to a flat planar configuration, an entertaining map of the instructions is visible, and extends over all of the panels 142, except the panel 142a, with the map on one side being in the English language, and in the Spanish language on the other side. When the instruction sheet 138 is folded in the accordion-like fashion, the sheet can be easily inserted into the container 88.

The pass code card 140 contains a unique access code 144, which allows the individual to access information stored, and to store information, at a common site where fixed and variable data files are located.

It is noted that all of the items which form the book kit 136, as described in the immediately three previous paragraphs, are all structured in the same manner as described above, with respect to the individual items.

In the making of the personalized book 40, an individual, who is the subject of the personalized story in the book, participates by providing personal data, and by using a computer in conjunction with facilities at a distant site. In the event that the individual, for any reason, such as, for example, immature age, physical handicaps, or the like, can not perform the necessary tasks to participate in the making of the book 40, another person can act on behalf of the individual and perform the necessary tasks. It is to be understood that, any reference below to the individual, will include reference to the person who is acting on behalf of the individual.

In order for the individual to participate in the making of the individual's personalized book 40, certain preparations must be made, and items associated with the book must be prepared and provided to the individual. This process may be accomplished in a retail or non-retail environment, where a developer of the process initially establishes interactive interfaces facilities, and makes the items required to make the personalized book 40. Further, the developer establishes a means of conveying to the individual the manner of using the facilities, and providing the items, to the individual to facilitate the individual's active participation in the making of the personalized book 40 containing the individual's personalized story.

Initially, the developer locates a common site where data can be stored, for access by the individual from a remote site geographically spaced from the common site. A fixed data file is then established at the common site for storing fixed data therein. A variable data file is also established at the common site for storing variable data therein. Fixed data, representative of nonvariable data to be printed on at least one page of the personalized book 40, is prepared and stored in the fixed data file.

The individual, who is the subject of the personalized story, and who is located at the remote site, selects variable data in the form of a word or phrase designating the individual. The individual facilitates the transmission of the variable data from the remote site to the common site, where the variable data is stored in the variable data file at the common site. The fixed data and the variable data are merged at the common site in a format of merged data, and transmitted to the remote site, where the merged data is displayed in a human-readable format.

The individual, at the remote site, can then facilitate the printing of the displayed merged data on the at least one page.

The common site in the above-described process is a server at a physical location of an Internet website facility having a prescribed website address.

Prior to the individual selecting the variable data, the individual is provided with the instructions printed on the panel 142a of the instruction sheet 138, regarding the manner of (1) producing the variable data at the remote site, and (2) transmitting the produced variable data to the variable data file at the common site.

In addition, the individual, who is located at the remote site, is also provided with a unique access code, listed on the pass code card 140 (FIG. 2), where the use of the access code allows the individual to access the variable data file for transmitting the variable data thereto.

Referring to FIG. 15, the opening 68 is formed in the front cover 54 of the personalized book 40 at a prescribed location. Thereafter, the merged data is printed at a precise area 146 on the at least one page. In this manner, the word or phrase, which designates the individual to be referenced in the personalized story, is visible at the precise area 146, and through the opening 68 formed in the front cover 54 when the at least one page is assembled with the front cover to form the personalized book 40.

As previously described, the expression “SAFARI ADVENTURE” has been stenciled into the portion of the plurality of slats 64, just below the opening 68, which is formed in the front cover 54. When the personalized book 40 is assembled, the individual's name in the possessive case, for example “JACOB'S,” has been printed on a lower portion of the sheet 58a, which portion is visible through the opening 68. When the individual's name and the stenciled expression are viewed together, the full title of the personalized book 40 is viewed as “JACOB'S SAFARI ADVENTURE.” The expression “SAFARI ADVENTURE” is also printed on the sheet 58a, below the individual's name, and is not visible through the opening 68, when the front cover 54 is closed. However, when the front cover 54 is opened, the full title, as noted above, appears on the sheet 58a.

Referring to FIG. 2, a plurality of the containers 88 are made. A set of various items, including the unbound rolled book cover 42a, the textless sheets 58a through 58f, the screw receptors 59d and 61d, the screws 59e and 61e, which are the means for securing together the book cover and the pages therein, the instruction sheet 138, and the pass code card 140, are deposited in each of the plurality of containers 88. The plurality of containers 88, each containing one set of the various items, are distributed to retailers for display and sale thereof. Each individual who purchases one of the plurality of containers 88 is provided with the facilities for the participation by the individual in the preparation of the individual's personalized story, and the making of the individual's personalized book 40.

It is noted that the subject of the personalized book 40 could be other than a human being. Also, the word or phrase could represent a characteristic unique to the individual, and not just the name of the individual.

After establishing a fixed data file, and a variable data file, in the server at the Internet website facility, fixed data is prepared in a format for storage, and is stored, in the fixed data file, where the fixed data relates, in an impersonalized manner, to the personalized story, without reference to any individual. A questionnaire is prepared requiring responses which reference, by the one or more words or phrases, the individual to be included in the personalized story. The questionnaire is then stored in a recallable data repository located in the server at the Internet website facility. The Internet address of the website, and the access code, unique to the individual, are provided to the individual, which facilitates access, through the Internet website facilities, to the questionnaire and the variable data file. The individual then accesses the server at the Internet website, from the remote site which is geographically spaced from the physical facility of the Internet website, through the use of (1) a computer located at the remote site, (2) the Internet address, and (3) the access code. The variable data generated by the individual, in response to the questionnaire, is transmitted to, and stored in, the variable data file at the Internet website facility. The fixed data and the variable data are then merged in the server, by use of a server-based application commercially identified as “FDFMerge Lite,” which is available from Appligent of Lansdowne, Pa. The merged data, which is representative of the completed personalized story, is transmitted through the Internet website facility to the remote site, and is displayed, at the remote site, in a human readable format.

The individual at the remote site is provided with the separate sheets 58a through 58f, whereafter the displayed merged data is printed onto the sheets in the human-readable format.

In a web-based method of making a plurality of the personalized books 40 for a plurality of individuals, each of the plurality of individuals will ultimately have a personalized book, relating a complete personalized story, distinctive from the personalized story of any other individual. Each of the plurality of individuals will receive the book kit 136 (FIG. 2) containing the instruction sheet 138 setting forth tasks for assisting in the preparation of the individuals personalized book 40. Such tasks are accomplished by the use of a computer at a first location, and through an interactive interface, including facilities of an Internet website at a second location, geographically spaced from the first location.

Initially, the services of an Internet website operator are engaged, where the operator has an Internet website facility, including a server, at the second location, and an Internet website address. A fixed data file, and a variable data file, are established in the server. Fixed data is prepared, and stored in, the fixed data file, where the fixed data relates to impersonalized aspects of the personalized story, without inclusion of, or reference to, any individual or characteristics associated therewith. A questionnaire is prepared, and stored in a recallable data repository in the server. The questionnaire requires responses which reference, by one or more words or phrases, the individual and one or more characteristics thereof, to be included in the individual's personalized story. An access code is prepared which will allow the individual to access the server, including the questionnaire, and the variable data file. The book kit 136 is distributed to the individual, who then logs on to the website. the questionnaire is transmitted from the second location to the first location for display on a monitor at the first location. Thereafter, the individual enters responses to the displayed questionnaire, in the form of personalized variable data, and the variable data is transmitted to the second location, and stored in the variable data file. The fixed data and the variable data are merged in the server at the second location, and is transmitted, as merged data, to the first location where the merged data is displayed on a monitor at the first location.

The plurality of book kits 136 may be distributed to retailers to display and sell the kits, as a first step in the commercial marketing of the making of the personalized book 40. Each individual/purchaser receives one of the plurality of book kits 136, which includes the instruction sheet 138 to facilitate completion of the individual's personalized book 40.

The book kit 136 includes the plurality of textless sheets 58a through 58f, which are provided to the individual, and the personalized story is thereafter printed on the sheets.

When responding to the questionnaire, the individual selects words and phrases which constitute the distinct designation of the individual, or one or more characteristics thereof.

The access code which is provided to the each of the plurality of individuals, with the instructions, is unique to the individual and is different from the access code provided to any other individual of the plurality of individuals.

The one or more characteristics provided by the individual in response to the questionnaire are selected from the group consisting of the individual's name, the individual's sex, an adult's name or relationship to the individual, a geographical location chosen by the individual where the personalized story is to take place, a type of pet chosen by the individual, the color of the individual's eyes, a character that is most fearsome to the individual, and the individual's initials.

Prior to printing the personalized story, the individual can review the monitor-displayed complete story, make desired changes, and print the personalized story, including any changes made by the individual.

To complete the making of the personalized book 40, the individual is provided with the book kit 136, which includes the book cover 42 and the means for securing together the cover and the printed sheets 58a through 58f. The means for securing includes the screw receptors 59d and 61d, and the screws 59e and 61e. Thereafter, the printed sheets 58a through 58f, in the form of pages, are assembled together, and secured together within the book cover 42

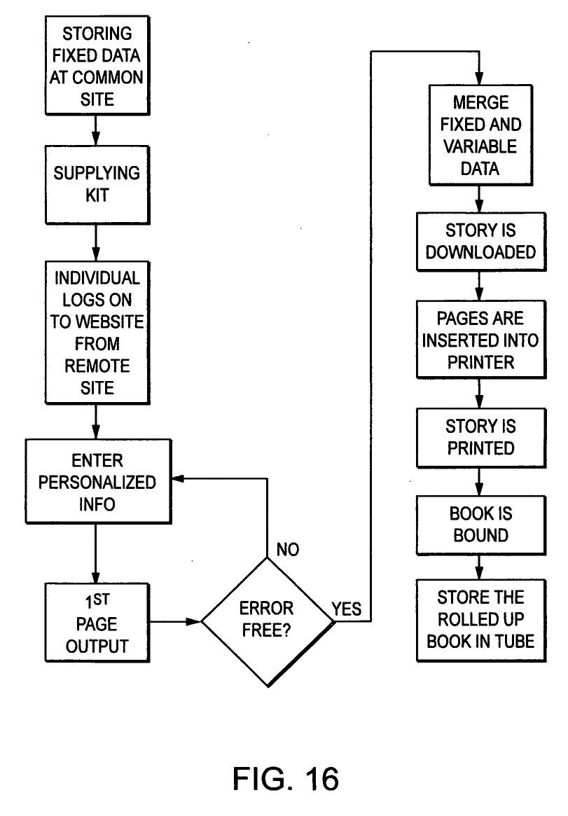

Another process for making the personalized book 40 follows the flow diagram illustrated in FIG. 16. Fixed data, as described above, is stored at the common site, and the book kit 136 is supplied to the individual. The individual then logs on to the website from the remote site, at which the individual is located. The individual enters personalized data, and the first page of the personalized data appears at a display output. If the first page contains errors, changes to the personalized data are made by the individual, and the first page is again displayed. If there are no errors in the displayed first page, the fixed data and the variable data are merged. The story is then downloaded by the individual, and pages are inserted into a printer, whereafter the personalized story is printed on the inserted pages. The book 40 is then bound, and rolled for storage in a container, such as, for example, the container 88, which could be considered a tube.

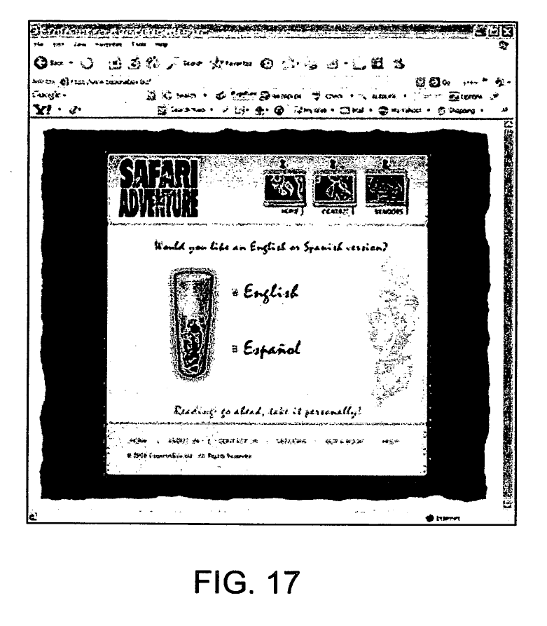

FIGS. 17 through 21 are a few of the many monitor screen displays, which the individual will view when processing through the various steps of the interactive interface with the Internet website leading to the making of the personalized book 40.

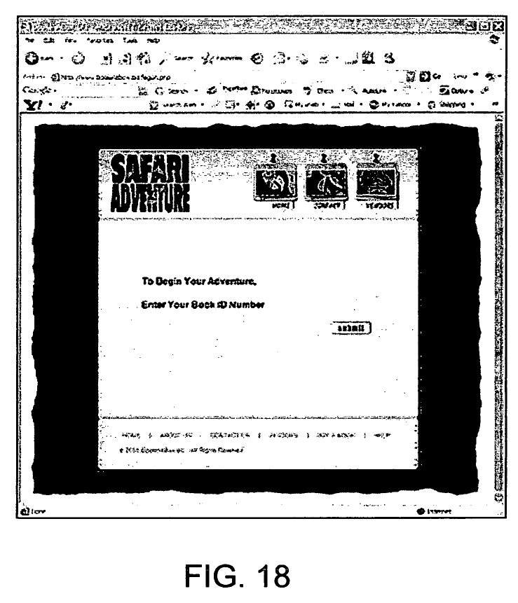

As shown in FIG. 17, the initial display viewed by the individual provides an opportunity for the individual to select in which language, English or Spanish, the individual wishes to have the questionnaire presented, and/or the personalized book 40 printed. In FIG. 18, the individual is asked whether the individual already has the book, that is, the book kit 136. If the individual does not have the book, the individual can order the book through the Internet connection. If the individual does have the book, or the book kit 136, the individual proceeds with the process as described above.

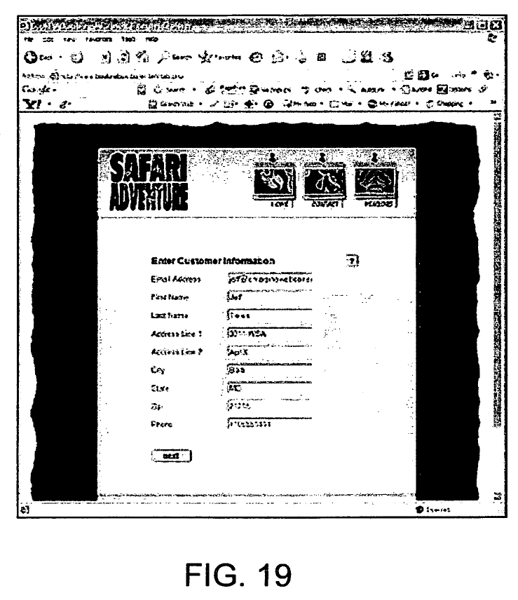

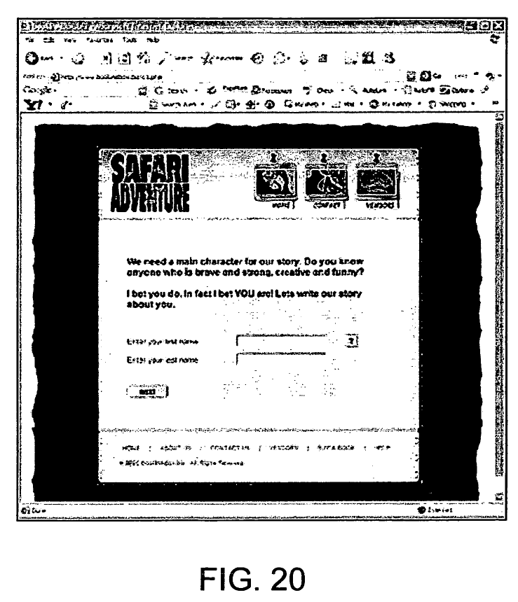

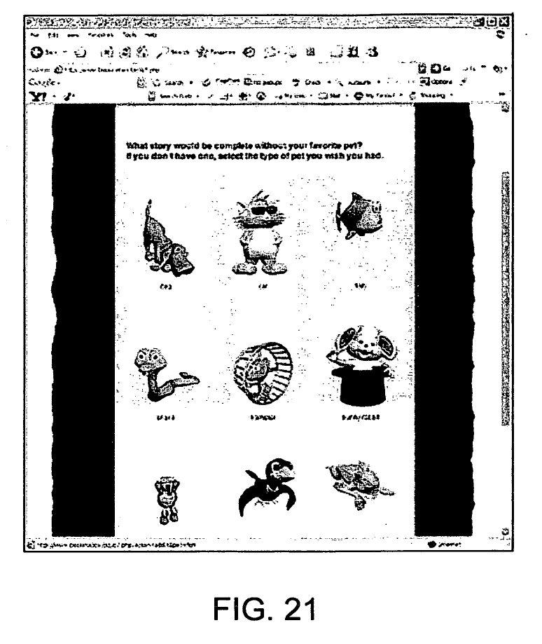

As shown in FIG. 19, the individual is asked to enter certain customer-related information, such as the individual's e-mail address, street address, and telephone number. In FIG. 20, a representative display is shown requesting input from the individual relating to the month, day and year, which could be the individual's birthday, that the individual wishes the personalized story to unfold. In FIG. 21, a representative display is shown requesting input from the individual relating to the individual's favorite pet, and if the individual does not have a pet, the individual can select a pet from the cartoon characters shown on the display.

The above-described remote site, where the individual is located, and which is geographically spaced from the location of the Internet website facilities, typically would be at the site where the individual's computer is located. However, without departing from the spirit and scope of the invention, the computer could be located at another site, other than the location of the individual's computer, where the another site is also geographically spaced from the location of the Internet website facility. The individual would use the computer at the another site in the same manner as when using the individual's computer, as described above, to complete the personalized story. The fixed data, the variable data, the questionnaire and the merge application software would continue to be stored in the serve at the Internet website facility. The interaction between the purchaser/individual and the facilities of the Internet website would be identical to the above-described interaction with the purchaser/individual's computer.

The another site could be one of many retail sites, such as, for example a kiosk or other retail store, where each retailer provides, for use by the purchaser/individual, a computer located at the retail site, and dedicated for such purpose. If the retailer chooses, an additional fee, above and beyond the cost of purchasing the book kit 136, could be charged for use of the computer by the purchaser/individual to complete the personalized story, in the same fashion that the individual would complete the story by use of the individual's computer. Or the retailer could include the cost, of using the retailer's computer, in the price of the book kit 136. The retailer's computers would be dedicated for the purpose of preparing the personalized story immediately upon the purchase of the book kit 136 at the retail site, and through the interaction of the purchaser/individual and the Internet website facilities.

The purchaser/individual of the book kit 136 would process through the preparing of the completed personalized story in the same manner as described above, with respect to the individual's computer, and would access, through the interactive interface, the facilities of the Internet website by use of the purchaser/individual's unique access code 144 and the Internet address of the website.

Thus, the purchaser/individual could walk into the retail site without a personalized book, purchase the book kit 136, use the retailer-provided computer to access the Internet website facilities, process the personalized story, print the story on the sheets 58a through 58f, assemble and secure the sheets within the book cover 42, and walk out of the retail site with the completed personalized book 40. This could be accomplished in a short period of time, and bring near-instant satisfaction for the purchaser/individual, who has not only participated in the making of the book 40, but has done so in the short period of time, and all with one trip to the retail site.

In general, the above-identified embodiments are not to be construed as limiting the breadth of the present invention. Modifications, and other alternative constructions, will be apparent which are within the spirit and scope of the invention as defined in the appended claims.

What is claimed is:

1. A method of making a personalized book containing a personalized story, which includes reference to a word or phrase, constituting the distinct designation of an individual, who is a subject of the story, as selected by the individual, or by a person acting for the individual, who facilitates the personalized preparation of at least one page of the story for ultimate assembly in the personalized book, which comprises the steps of:
establishing a fixed data file for storing fixed data therein;
establishing a variable data file for storing variable data therein;
locating the fixed data file and the variable data file at a common site;
storing fixed data in the fixed data file representative of nonvariable data to be printed on the at least one page of the personalized book;
selecting, by the individual, or the person, at a remote site spaced geographically from the common site, variable data in the form of the word or phrase designating the individual to be referenced in the story;
transmitting the variable data from the remote site to the common site;
storing the transmitted variable data in the variable data file;
merging the fixed data and the variable data at the common site into a format of merged data;
transmitting the merged data from the common site to the remote site; and
displaying the merged data in a human-readable format at the remote site.

2. The method of making a personalized book as set forth in claim 1, which further comprises the step of:
printing the displayed merged data on the at least one page at the remote site.

3. The method of making a personalized book as set forth in claim 1, which further comprises:
the common site being a server at a physical location of an Internet website facility having a prescribed website address.

4. The method of making a personalized book as set forth in claim 1, which, prior to the step of selecting, further comprises the step of:
providing the individual, or the person, at the remote site with instructions regarding the manner of (1) producing the variable data at the remote site, and (2) transmitting the produced variable data to the variable data file at the common site.

5. The method of making a personalized book as set forth in claim 2, wherein the personalized book has a front cover, which further comprises the steps of:
forming an opening through the front cover at a prescribed location; and
printing the merged data at a precise area on the at least one page so that at least some portions of the printed data is visible through the opening formed in the front cover when the at least one page is assembled with the front cover to form the personalized book.

6. The method of making a personalized book as set forth in claim 1, which further comprises the steps of:
making a plurality of containers;
depositing into each of the plurality of containers various items, including an unbound book cover, textless sheets which eventually form pages of the personalized book, means for securing together the book cover and the pages, and an instruction sheet for guiding the individual, or the person, in making the individual's personalized book; and
distributing the plurality of containers, with the various items therein, to retailers for display and sale thereof, where each individual, or person, who purchases one of the plurality of containers is provided with facilities for the participation by the individual, or the person, in the preparation of the individual's personalized story, and the making of the individual's personalized book.

7. The method of making a personalized book as set forth in claim 4, which further comprises the step of:
providing a unique access code to the individual, or the person, the use of which allows the individual, or the person, to access the variable data file for transmitting the variable data thereto.

8. The method of making a personalized book as set forth in claim 1, wherein the subject of the story is other than a human being.

9. The method of making a personalized book as set forth in claim 1, wherein the word or phrase represents a characteristic unique to the individual.

10. A method of making a personalized book containing a personalized story, which includes reference to one or more words or phrases, constituting the distinct designation of an individual, who is the subject of the story, as selected by the individual, or a person acting for the individual, who facilitates the personalized preparation of one or more pages of the story for ultimate assembly in the personalized book, which comprises the steps of:
establishing, in a server located at a physical location of an Internet website facility, a fixed data file for storing fixed data therein;
establishing, in the server at the Internet website facility, a variable data file for storing variable data therein;
preparing fixed data in a format for storage in the fixed data file, where the fixed data relates, in an impersonalized manner, to the story, without reference to any individual;
storing the fixed data in the fixed data file;
preparing a questionnaire requiring responses which reference, by the one or more words or phrases, the individual to be included in the personalized story;
storing the questionnaire in a recallable data repository located in the server at the Internet website facility;
providing, to the individual, or the person, (1) the Internet address of the website, and (2) an access code unique to the individual, which facilitates access, through the website facilities, to the questionnaire and to the variable data file;
accessing the server at the Internet website facility, by the individual, or the person, at a remote site geographically spaced from the Internet website facility, through the use of (1) a computer located at the remote site, (2) the Internet address, and (3) the access code;
transmitting, from the remote site, the variable data, generated by the individual, or the person, in response to the questionnaire, to the variable data file at the Internet website facility;
storing the transmitted variable data in the variable data file;
merging the fixed data and the variable data in the server at the Internet website facility into a format of merged data representative of the complete personalized story;
transmitting the merged data from the server at the Internet website facility to the remote site; and
displaying, at the remote site, the merged data in a human-readable format.

11. The method of making a personalized book as set forth in claim 10, which further comprises the step of:
providing, to the individual, or the person, separate sheets of paper, which eventually form pages of the personalized book; and
printing the displayed merged data onto the separate sheets of paper in the human-readable format.

12. A web-based method of making a plurality of personalized books for a plurality of individuals thereof, where each of the plurality of individuals will ultimately have a personalized book, relating a complete personalized story, distinctive from the personalized book and story of any other individual of the plurality of individuals, and wherein each individual, or person acting for the individual, will receive a kit containing instructions setting forth tasks for assisting in the preparation of the individual's personalized book, by use of a computer, at a first location, and through an interactive interface including facilities of an Internet website at a second location, geographically spaced from the first location, which comprises the steps of:
engaging the services of an Internet website operator, having an Internet website facility and a server at the second location, and an Internet website address;
establishing, in the server, a fixed data file for storing fixed data therein;
establishing, in the server, a variable data file for storing variable data therein;
preparing fixed data in a format for storage in the fixed data file, where the fixed data relates to impersonalized aspects of the story, without inclusion of or reference to any individual or characteristics associated with an individual;
storing the fixed data in the fixed data file;
preparing a questionnaire requiring responses which reference, by one or more words or phrases, the individual, and one or more characteristics thereof, to be included in the individual's personalized story;
storing the questionnaire in a recallable data repository located in the server;
preparing an access code which will allow the individual, or the person, to access the server, including the questionnaire stored in the recallable data repository, and the variable data file for deposit of variable data therein;
distributing the kit to the individual, or the person, where the kit includes (1) the Internet address of the website, and (2) the access code;
logging on to the website, by the individual, or the person, at the first location, through the use of (1) the computer located at the first location, (2) the Internet address, and (3) the access code, to establish an interactive interface between the individual, or the person, and the Internet website facilities at the second location;
transmitting the questionnaire from the second location to the first location for display on a monitor at the first location;
entering, by the individual, or the person, at the first location, responses to questions on the displayed questionnaire, which form variable data representing personalized information regarding the individual;
transmitting, from the first location, the variable data, generated by the individual, or the person, in response to the questionnaire, to the variable data file at the second location;
storing the transmitted variable data in the variable data file;
merging the fixed data and the variable data, in the server at the second location, into a format of merged data representative of a complete personalized story unique to the individual;
transmitting the merged data from the server at the second location to the first location; and
displaying, on a monitor at the first location, the merged data in a human-readable format, of the complete personalized story.

13. The web-based method of making a plurality of personalized books as set forth in claim 12, which further comprises the step of:
distributing, after preparing the access code, a plurality of the kits, with each kit including (1) the Internet address of the website, and the (2) the access code, to retailers for display and sale thereof, where each purchaser of one of the kits is provided with the instructions therein to facilitate completion of the individuals personalized book.

14. The web-based method of making a plurality of personalized books as set forth in claim 12, which further comprises the steps of:
providing to the individual, or the person, inclusive of the kit, a plurality of textless sheets prepared for the personalized printing of the personalized story thereon; and
printing the merged data onto the plurality of textless sheets.

15. The web-based method of making a plurality of personalized books as set forth in claim 12, which further comprises the step of:
selecting by the individual, or the person, in response to the questionnaire, words and phrases which constitute the distinct designation of the individual, or one or more characteristics thereof.

16. The web-based method of making a plurality of personalized books as set forth in claim 12, wherein the access code provided to each individual, or the person, with the instructions, is unique to the individual and is different from the access code provided to any other individual of the plurality of individuals.

17. The web-based method of making a plurality of personalized books as set forth in claim 12, wherein the receipt of the instructions, and the tasks to be performed in accordance with the instructions, can be performed by the individual, or any one acting on behalf of the individual.

18. The web-based method of making a plurality of personalized books as set forth in claim 12, wherein the one or more characteristics of the individual are selected from the group consisting of the individual's name, individual's sex, adult's name and/or relationship of adult to the individual, individual-chosen geographical site where personalized story takes place, individual-chosen type of pet, individual-chosen name of pet, color of individual's eyes, individual-chosen most fearsome character, and individual's initials.

19. The web-based method of making a plurality of personalized books as set forth in claim 12, which further comprises the step of:
reviewing on the monitor display, by the individual, or the person, at least a portion the complete personalized story;
making any changes to the at least a portion of the complete personalized story as desired by the individual, or the person, and
printing pages of the complete personalized story including any changes made by the individual, or the person.

20. The web-based method of making a plurality of personalized books as set forth in claim 19, which further comprises the step of:
providing to the individual a cover, within the kit, for the personalized book, and means to secure together the cover and the printed pages therein;
assembling the printed pages within the cover in a book format; and
securing together the assembled cover and the printed pages therein to complete the personalized book.

21. A book, which comprises:
a book cover formed by a plurality of independent slats extending from a top edge of the book cover to a bottom edge of the book cover,
the plurality of independent slats arranged in a side-by-side separated relation, and located in a common plane when the book cover is in a flat plane; and
means for retaining the plurality of independent slats of the book cover in their side-by-side separated relation.

22. The book as set forth in claim 21, which further comprises:
means for allowing the book cover to be rolled to form a rolled book.

23. The book as set forth in claim 21, wherein the book is a rolled book with the book cover being in a cylindrical-like configuration.

24. The book as set forth in claim 21, which further comprises:
the book cover being formed with a spine, which is located intermediate a first side edge of the book cover and a second side edge of the book cover, and which extends from the top edge of the book cover to the bottom edge of the book cover;
the book cover being foldable along the spine thereof;
a front cover of the book formed by a first portion of the book cover, which extends laterally from the spine to the first side edge of the book cover;
a back cover of the book formed by a second portion of the book cover, which extends laterally from the spine to the second side edge of the book cover; and
means for allowing the front cover and the back cover to be rolled to form a rolled book.

25. The book as set forth in claim 21, wherein the plurality of independent slats are composed of a material selected from the group of bamboo, wood, plastic, metal, paperboard, and any combination of two or more of bamboo, wood, plastic, metal, and paperboard.

26. A book, which comprises:
a cover having an opening formed in a portion thereof;
a first portion of the edge of the opening having an appearance of the cover having been randomly torn from the remaining adjacent sections of the cover;
a second portion of the edge of the opening formed with spaced notches;
a sheet placed within the cover; and
a graphic illustration of a paw and claws of an animal appearing on the sheet, which is visible through the opening in the cover, with the graphic illustration of the claws being visible through the notches to represent that the opening in the cover has been formed by the claws of the animal from within the cover.

27. The book as set forth in claim 26, wherein the book contains a personalized story coauthored by the holder of the book, which further comprises:
a title of the book being stenciled on the cover of the book between a lower edge of the opening formed in the cover and a lower edge of the cover; and
a word or phrase, constituting the distinct designation of the coauthor of the personalized story, appearing on the sheet with the graphic illustration and visible through the opening of the cover.

28. The book as set forth in claim 27, which further comprises:
the title being printed on the sheet coinciding in placement with the title stenciled on the cover of the book, and not being visible through the opening of the cover when the cover is closed, and being visible when the cover is opened, where the title on the sheet is spaced below the word or phrase by the same distance that the title stenciled on the cover is spaced below the word or phrase when the book is closed.

29. A book kit, which comprises:
a container formed with a closed base, and an open top spaced from the closed base, with an axis extending between the base and the open top of the container;
the container formed with a well having a closed side wall which extends along the axis of the container from the base of the container toward the open top of the container;
the well of the container formed with a prescribed transaxial dimension
a cover of a book having a prescribed width dimension extending between a first side edge of the cover and a spaced second side edge of the cover when the cover is in a flat plane;
the prescribed width dimension of the cover of the book being greater than the prescribed transaxial dimension of the well of the container;
the cover of the book being structured to allow rolling of the book about an axis to thereby form a rolled book, with the rolled book having a transaxial dimension which is less than the prescribed transaxial dimension of the well of the container; and
the rolled book being locatable within the well of the container.

30. The book kit as set forth in claim 29, wherein the cover of the book is a front cover, which further comprises:
the front cover of the book formed by a plurality of independent slats, with each of the plurality of independent slats extending longitudinally from a top edge to a bottom edge thereof;
the plurality of independent slats of the front cover arranged in a side-by-side separated relation, and located in a common plane when the front cover is in the flat plane; and
means for retaining the plurality of independent slats of the front cover in the side-by-side separated relation.

31. The book kit as set forth in claim 30, which further comprises:
the book being formed with a back cover which is structurally identical to the front cover.

32. The book kit as set forth in claim 29, wherein the plurality of independent slats are composed of a material which is selected from the group of bamboo, wood, plastic, metal, paperboard, and any combination of two or more of bamboo, wood, plastic, metal, and paperboard.

33. The book kit as set forth in claim 29, which further comprises:
the open top of the container being beveled.

34. The book kit as set forth in claim 33, which further comprises:
means for attaching the container to a support.

35. The book kit as set forth in claim 29, which further comprises:
a cap positionable on the open top of the container.

36. The book kit as set forth in claim 29, which further comprises:
the container being shaped in a configuration of a bottle;
a side opening formed in the side wall of the well; and
a removable side-panel positionable over, and forming a closure for, the side opening in the side wall of the well, to facilitate access to the well within the closed side wall of the container.

37. The book kit as set forth in claim 36, which further comprises:
the well extending axially from the base to an intermediate section of the container; and
a neck extending axially from the intermediate section of the container to the open top thereof, formed with an axial opening extending from the open top toward the base, with the axial opening having a transaxial dimension which is less than the prescribed transaxial dimension.

38. The book kit as set forth in claim 36, which further comprises:
a decorative emblem located on the open top of the container and extending in a direction away from the container.

39. The book kit as set forth in claim 36, which further comprises:
the cover of the book including a back cover;
a ledge formed at a lower edge of the side opening on a first side of the container for engaging an edge of, and supporting, the book in an unrolled configuration; and
spaced supports formed in the container extending from the ledge toward the open top of the container and angularly away from the ledge toward a second side of the container, opposite the first side thereof, for engaging the back cover of, and supporting, the book.

40. The book kit as set forth in claim 39, which further comprises:
a stop wall extending from the ledge, and positioned to engage a portion of the book, to prevent the edge of the book from moving from the ledge in a direction away from the axis of the container.

41. The book kit as set forth in claim 39, which further comprises:
the well extending axially from the base to an intermediate section of the container;
a neck formed in the container and having an axial opening extending from the open top of the container toward the base thereof, the axial opening formed with a transaxial dimension which is less than the prescribed transaxial dimension, and the neck extending axially from the intermediate section of the container to the open top thereof; and
a lamp located within the axial opening of the neck of the container for illuminating the book supported on the ledge and by the spaced supports.

42. A book stand for supporting a book having a front cover and a back cover, which comprises:
a support mount shaped in a configuration of a bottle having an axis extending from a closed base of the support mount to a top of the support mount, and formed with a side wall;
the support mount formed with a support-mount well extending from the closed base toward the top of the support mount and surrounded, at least partially, by the side wall;
a side opening formed in an intermediate section of the support mount, with the side opening being in communication with the well of the support-mount;
the side opening having a lower edge adjacent the closed base and an upper edge closer to the top than the lower edge;
a ledge formed at the lower edge of the side opening on a first side of the support mount for engaging an edge of, and supporting, the book; and
spaced supports formed in the support mount extending from the ledge toward the upper edge of the side opening of the support mount and angularly away from the ledge toward a second side of the support mount, opposite the first side thereof, for engaging the back cover of, and supporting, the book.

43. The book stand as set forth in claim 42, which further comprises:
a neck formed on, and extending axially from the intermediate section of, the support mount to the top thereof.

44. The book stand as set forth in claim 42, which further comprises:
a stop wall extending from the ledge, and positioned to engage a portion of the book, to prevent movement of the book from the ledge in a direction away from the axis of the support mount.

45. The book stand as set forth in claim 43, which further comprises:
the neck of the support mount formed with an axial opening extending from the top of the support mount inward toward the closed base thereof, with the axial opening having a transaxial dimension which is less than the prescribed transaxial dimension, and
a lamp located within the axial opening of the neck of the support mount for illuminating the book supported on the ledge and by the spaced supports.

46. The book stand as set forth in claim 42, which further comprises:
a decorative emblem located on the top of the support mount.
